(19) United States
(12) Patent Application Publication
(10) Pub. No.: US 2018/0118965 A1
(43) Pub. Date: May 3, 2018

(54) AQUEOUS INKJET INK, INKJET RECORDING METHOD, AND INKJET RECORDING DEVICE

(71) Applicant: Roland DG Corporation, Hamamatsu-shi (JP)

(72) Inventors: Shinji TABUCHI, Hamamatsu-shi (JP); Aoi TANAKA, Hamamatsu-shi (JP)

(21) Appl. No.: 15/726,715

(22) Filed: Oct. 6, 2017

(30) Foreign Application Priority Data
Nov. 2, 2016 (JP) 2016-214940

(51) Int. Cl. C09D 11/38; C09D 11/322; C09D 11/328

(52) U.S. Cl. CPC C09D 11/38; B41J 11/002; C09D 11/328; C09D 11/322

(57) ABSTRACT

An aqueous inkjet ink includes at least water, a coloring material, a water-soluble organic solvent component, a surfactant, resin particles, and a water-soluble carbodiimide compound that acts as a crosslinking component. The surfactant is a silicone-based surfactant. The resin microparticles include a functional group reactive with a carbodiimide group at least at a surface thereof. A mass ratio of the resin microparticles with respect to the water-soluble carbodiimide compound is about 10 or greater.

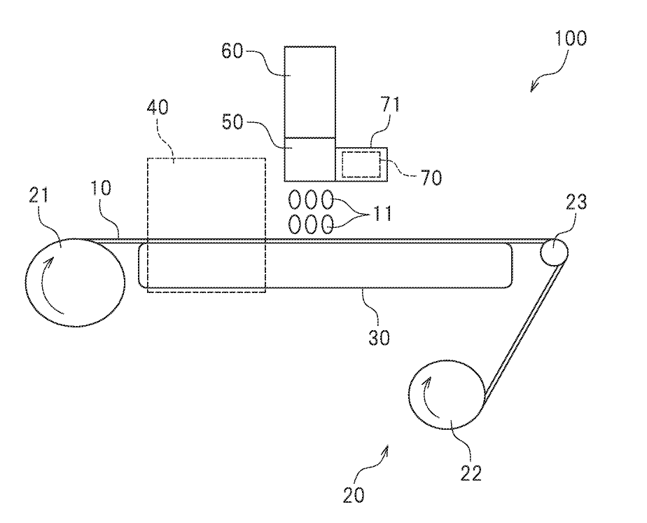

### CROSS REFERENCE TO RELATED APPLICATIONS

This application claims the benefit of priority to Japanese Patent Application No. 2016-214940 filed on Nov. 2, 2016. The entire contents of this application are hereby incorporated herein by reference.

### BACKGROUND OF THE INVENTION

### 1. Field of the Invention

The present invention relates to aqueous inkjet inks, and to inkjet recording methods and inkjet recording devices using the aqueous inkjet inks.

### 2. Description of the Related Art

An inkjet printer using an inkjet recording system has the advantages of, for example, being easy to operate, generating little noise, and allowing color printing to be performed easily, and thus is in wide use as a home-use or office-use output device. Recently, an inkjet printer is also applied to industrial uses for, for example, displays, posters, signboards and the like.

The inkjet recording system is a recording system that directly ejects an ink liquid drop toward a medium from a very small nozzle and causes the ink liquid drop to adhere to the medium, thus providing a letter or an image. For industrial uses, a non-absorbent substrate is often used as a medium. One representative non-absorbent substrate is a poly(vinyl chloride) (PVC) substrate.

For printing (for forming an image) on a PVC substrate, an eco-solvent-based inkjet ink containing a glycolether-based solvent and a resin-soluble solvent (e.g., lactone, etc.) is suitable. The eco-solvent-based inkjet ink dissolves a surface of the PVC substrate and coats the surface of the PVC substrate with a pigment and a fixing resin to form an image. Therefore, the eco-solvent-based inkjet ink provides a high image quality with little ink bleeding, and has a high adhesion and a high waterproofness. During the image formation, the eco-solvent-based inkjet ink is penetration-dried and evaporation-dried, and therefore is dried very quickly.

However, there is a concern that the volatilized solvent of the eco-solvent-based inkjet ink may adversely influence the environment and the human body. Therefore, aqueous inkjet inks suitable for printing on a PVC substrate are desired and are now being progressively developed. Such aqueous inkjet inks typically include water, a water-soluble organic solvent, a coloring material, and resin microparticles as a fixing component. Japanese Laid-Open Patent Publication No. 2015-193788 describes that addition of a carbodiimide compound to an aqueous inkjet ink provides an image having superb rubfastness and the like.

In general, aqueous inkjet inks form an image that is clouded in white as compared with eco-solvent-based inkjet inks. As can be seen from this, the aqueous inkjet inks have a problem of having a low optical concentration value (OD value). Nonetheless, Japanese Laid-Open Patent Publication No. 2015-193788 does not discuss the optical concentration value, and the technology described in Japanese Laid-Open Patent Publication No. 2015-193788 does not solve the problem of the low optical concentration value. In addition, studies made by the present inventors led to the discovery that the technology described in Japanese Laid-Open Patent Publication No. 2015-193788 has room for improvement in the ink bleeding from an image and the rubfastness.

### SUMMARY OF THE INVENTION

Preferred embodiments of the present invention provide aqueous inkjet inks that, when used to print on a PVC substrate, form an image with little ink bleeding, a high optical concentration value, and superb rubfastness.

An aqueous inkjet ink according to a preferred embodiment of the present invention includes at least water (A); a coloring material (B); a water-soluble organic solvent component (C); a surfactant (D); and resin particles (E). The aqueous inkjet ink according to a preferred embodiment of the present invention further includes a water-soluble carbodiimide compound (F) that acts as a crosslinking component. The surfactant (D) is preferably a silicone-based surfactant. The resin microparticles (E) include a functional group that is reactive with a carbodiimide group at least at a surface thereof. A mass ratio (E)/(F) of the resin microparticles (E) with respect to the water-soluble carbodiimide compound (F) in the aqueous inkjet ink is 10 or greater.

An inkjet recording method according to a preferred embodiment of the present invention includes the steps of ejecting the above-described aqueous inkjet ink toward a medium including a non-absorbent substrate; and drying the aqueous inkjet ink ejected on the medium to form an ink film.

An inkjet recording device according to a preferred embodiment of the present invention includes a conveyer that transports a medium including a non-absorbent substrate; a heater that heats the transported medium; an ejector that ejects an inkjet ink toward the heated medium; and an ink container that contains the inkjet ink and supplies the inkjet ink to the ejector. The inkjet ink is the above-described aqueous inkjet ink.

Preferred embodiments according to the present invention provide aqueous inkjet inks that, when used to print on a PVC substrate, form an image with little ink bleeding, a high optical concentration value, and superb rubfastness.

The above and other elements, features, steps, characteristics and advantages of the present invention will become more apparent from the following detailed description of the preferred embodiments with reference to the attached drawings.

### BRIEF DESCRIPTION OF THE DRAWINGS

The FIGURE is a conceptual view of an inkjet recording device according to a preferred embodiment of the present invention.

### DETAILED DESCRIPTION OF THE PREFERRED EMBODIMENTS

Aqueous inkjet inks according to preferred embodiments of the present invention include at least water (A); a coloring material (B); a water-soluble organic solvent component (C); a surfactant (D); resin particles (E); and a water-soluble carbodiimide compound (F) that acts as a crosslinking component. The surfactant (D) is preferably a silicone-based surfactant. The resin microparticles (E) include a functional group that is reactive with a carbodiimide group at least at a surface of the resin microparticles (E). A mass ratio (E)/(F) of the resin microparticles (E) with respect to the water-soluble carbodiimide compound (F) in the aqueous inkjet ink is 10 or greater.

### Water (A)

An aqueous inkjet ink according to a preferred embodiment of the present invention includes water (A). Due to the presence of water (A), the aqueous inkjet ink has an advantage of having a small environmental load. There is no specific limitation on the type of water (A) used in the inkjet ink. From the point of view of preventing incorporation of impurities, ion exchange water, ultrafiltration water, reverse osmosis water, distilled water, and ultrapure water are preferable. Ion exchange water is more preferable.

The content of the water (A) in the aqueous inkjet ink according to a preferred embodiment of the present invention is, for example, preferably about 40% by mass or greater, more preferably about 45% by mass or greater, and still more preferably about 50% by mass or greater. The content of the water (A) in the inkjet ink according to a preferred embodiment of the present invention is, for example, preferably about 80% by mass or less, more preferably about 75% by mass or less, and still more preferably about 70% by mass or less.

### Coloring Material (B)

As the coloring material (B), for example, a dye, a pigment or the like is usable. A single type of coloring material may be used, or two or more types of coloring materials may be combined at any ratio.

As the dye, any of various dyes known to be usable for an aqueous inkjet ink is usable. Examples of such usable dyes include a direct dye, an acid dye, a food dye, a basic dye, a reactive dye, a dispersion dye, a vat color dye, and the like.

The dye will be described in more detail. Examples of cyan dyes include C. I. Acid Blue 1, 7, 9, 15, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 199, 203, 204, 205, 229, 234, 236, and 249; C. I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, and 249; C. I. Reactive Blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, and 46; C. I. Food Blue 1 and 2; C. I. Basic Blue 9, 25, 28, 29, and 44; and the like.

Examples of magenta dyes include C. I. Acid Red 1, 6, 8, 9, 13, 14, 18, 26, 27, 32, 35, 37, 42, 51, 52, 57, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 249, 252, 254, 262, 265, 274, 282, 289, 303, 317, 320, 321, and 322; C. I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, and 231; C. I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, and 64; C. I. Food Red 7, 9, and 14; and the like.

Examples of yellow dyes include C. I. Acid Yellow 1, 3, 11, 17, 19, 23, 25, 29, 36, 38, 40, 42, 44, 49, 59, 61, 70, 72, 75, 76, 78, 79, 98, 99, 110, 111, 127, 131, 135, 142, 162, 164, and 165; C. I. Direct Yellow 1, 8, 11, 12, 24, 26, 27, 33, 39, 44, 50, 58, 85, 86, 87, 88, 89, 98, 110, 132, 142, and 144; Reactive Yellow 1, 2, 3, 4, 6, 7, 11, 12, 13, 14, 15, 16, 17, 18, 22, 23, 24, 25, 26, 27, 37, and 42; C. I. Food Yellow 3 and 4; and the like.

Examples of black dyes include C. I. Direct Black 1, 7, 19, 32, 51, 71, 108, 146, 154, and 166; and the like.

Examples of dyes other than the cyan, magenta, yellow and black dyes include C. I. Acid Green 7, 12, 25, 27, 35, 36, 40, 43, 44, 65, and 79; C. I. Direct Green 1, 6, 8, 26, 28, 30, 31, 37, 59, 63, and 64; C. I. Reactive Green 6 and 7; C. I. Direct Violet 2, 48, 63, and 90; C. I. Reactive Violet 1, 5, 9, and 10; and the like.

As the pigment, either an inorganic pigment or an organic pigment may be used.

Examples of organic pigments include an azo pigment (e.g., an azo lake pigment, an insoluble azo pigment, a condensed azo pigment, a chelating azo pigment, etc.); a polycyclic pigment (e.g., a phthalocyanine pigment, a perylene pigment, a perinone pigment, an anthraquinone pigment, a quinacridone pigment, a dioxazine pigment, an indigo pigment, a thioindigo pigment, an isoindolinone pigment, a quinofuranone pigment, etc.), a dye chelate (e.g., a basic dye-based chelate, an acid dye-based chelate, etc.), a nitro pigment, a nitroso pigment, an aniline black pigment, and the like.

Examples of inorganic pigments include titanium oxide, zinc oxide, zinc sulfide, white lead, calcium carbonate, settleable barium sulfate, white carbon, alumina white, kaolin clay, talc, bentonite, black iron oxide, cadmium red, red iron oxide, molybdenum red, molybdate orange, chrome vermillion, chrome yellow, cadmium yellow, yellow iron oxide, titanium yellow, chromium oxide, viridian, titanium cobalt green, cobalt green, cobalt chrome green, victoria green, ultramarine, Prussian blue, cobalt blue, cerulean blue, cobalt silica blue, cobalt zinc silica blue, manganese violet, cobalt violet, and the like.

More specifically, examples of black-type pigments include carbon black pigments (C. I. pigment black 7) such as furnace black, lamp black, acetylene black, channel black and the like; metal pigments such as copper, iron (C. I. pigment black II), and the like; metal oxide pigments such as titanium oxide and the like; organic pigments such as aniline black (C. I. pigment black 1); and the like.

Examples of cyan-type pigments include C. I. pigment blue 1, 2, 3, 15:1, 15:3, 15:4, 15:6, 16, 21, 22, 60, and 64; and the like.

Examples of magenta-type pigments include C. I. pigment red 5, 7, 9, 12, 31, 48, 49, 52, 53, 57, 97, 112, 120, 122, 146, 147, 149, 150, 168, 170, 177, 178, 179, 184, 188, 202, 206, 207, 209, 238, 242, 254, 255, 264, 269, and 282; C. I. pigment violet 19, 23, 29, 30, 32, 36, 37, 38, 40, and 50; and the like.

Examples of yellow-type pigments include C. I. pigment yellow 1, 2, 3, 12, 13, 14, 16, 17, 20, 24, 74, 83, 86, 93, 94, 95, 109, 110, 117, 120, 125, 128, 129, 137, 138, 139, 147, 148, 150, 151, 154, 155, 166, 168, 180, 185, and 213; and the like.

Examples of other pigments include C. I. pigment green 7, 10, and 36; C. I. pigment brown 3, 5, 25, and 26; C. I. pigment orange 2, 5, 7, 13, 14, 15, 16, 24, 34, 36, 38, 40, 43, 62, 63, 64, and 71; and the like.

Among such pigments, black-type pigments, especially, carbon black pigments, are preferable because such pigments provide an especially high effect of a preferred embodiment of the present invention, namely, the effect of forming an image having a high optical concentration value.

In addition, a pigment including a hydrophilic group such as a carboxyl group, a sulfonic acid group, a phosphonic acid group, a hydroxyl group or the like at a surface thereof (so-called “self-dispersing pigment”) may be used. Examples of carbon black-type self-dispersing pigments include CAB-O-JET 200, 300, 352K, and 400 (produced by Cabot Corporation); and the like. Examples of cyan-type self-dispersing pigments include CAB-O-JET 250C, 450C, and 554B (produced by Cabot Corporation); and the like. Examples of magenta-type self-dispersing pigments include CAB-C-JET 260M, 265M, and 465M (produced by Cabot Corporation); and the like. Examples of yellow-type self-dispersing pigments include CAB-O-JET 270Y, 470Y, and 740Y (produced by Cabot Corporation); and the like. As the coloring material (B), a self-dispersing pigment, which is dispersible in the water (A) with no use of a dispersant, is preferable.

The content of the coloring material (B) in the aqueous inkjet ink according to a preferred embodiment of the present invention is, for example, preferably about 0.1% by mass or greater, more preferably about 0.5% by mass or greater, and still more preferably about 1% by mass or greater as the solid quantity (solid content concentration). The content of the coloring material (B) in the aqueous inkjet ink according to a preferred embodiment of the present invention is, for example, preferably about 10% by mass or less, more preferably about 7.5% by mass or less, and still more preferably about 5% by mass or less as the solid quantity (solid content concentration).

### Water-Soluble Organic Solvent Component (C)

In this specification, the “water-soluble organic solvent” used as the water-soluble organic solvent component (C) refers to an organic solvent having a solubility of about 500 g/L or greater with respect to water at 20° C. A preferable water-soluble organic solvent is uniformly miscible in water at any ratio at 20° C.

As the water-soluble organic solvent (C), any water-soluble organic solvent known as a water-soluble organic solvent for aqueous inkjet inks may be used with no specific limitation. Examples of the water-soluble organic solvents include diols such as ethylene glycol (boiling point: about 196° C.), diethylene glycol (boiling point: about 244° C.), triethylene glycol (boiling point: about 287° C.), propylene glycol (boiling point: about 188° C.), dipropylene glycol (boiling point: about 230° C.), 1,3-propanediol (boiling point: about 213° C.), 1,2-butanediol (boiling point: about 194° C.), 2,3-butanediol (boiling point: about 183° C.), 1,3-butanediol (boiling point: about 208° C.), 2,2-dimethyl-1,3-propanediol (boiling point: about 208° C.), 2-methyl-1,3-propanediol (boiling point: about 213° C.), 1,2-pentanediol (boiling point: about 206° C.), 2,4-pentanediol (boiling point: about 201° C.), 2-methyl-2,4-pentanediol (boiling point: about 198° C.), 1,5-pentanediol (boiling point: about 242° C.), 1,2-hexanediol (boiling point: about 224° C.), 1,6-hexanediol (boiling point: about 250° C.), 2-ethyl-1,3-hexanediol (boiling point: about 243° C.), and the like; monools such as triethyleneglycolmonobutylether (boiling point: about 278° C.), dipropyleneglycolmonomethylether (boiling point: about 190° C.), propyleneglycol-n-butylether (boiling point: about 171° C.), propyleneglycol-t-butylether (boiling point: about 153° C.), diethyleneglycolmonobutylether (boiling point: about 230° C.), diethyleneglycolmonoethylether (boiling point: about 202° C.), diethyleneglycolmonomethylether (boiling point: about 194° C.), ethyleneglycol-n-propylether (boiling point: about 150° C.), ethyleneglycol-n-butylether (boiling point: about 171° C.), 3-methoxy-3-methyl-1-butanol (boiling point: about 174° C.), 3-methoxy-1-butanol (boiling point: about 158° C.), 1-ethoxy-2-propanol (boiling point: about 132° C.); and the like. These solvents may be used independently, or any two such solvents may be combined at any ratio.

The water-soluble organic solvent component (C) preferably includes a diol, which improves the moisture retaining property of the aqueous inkjet ink. The content of the diol in the aqueous inkjet ink according to a preferred embodiment of the present invention is, for example, preferably about 1.5% by mass or greater, and more preferably about 3% by mass or greater. The content of the diol in the aqueous inkjet ink according to a preferred embodiment of the present invention is, for example, preferably about 20% by mass or less, and more preferably about 15% by mass or less.

The water-soluble organic solvent component (C) preferably includes 3-methoxy-1-butanol, which improves the quick drying property of the aqueous inkjet ink according to a preferred embodiment of the present invention. The content of 3-methoxy-1-butanol in the aqueous inkjet ink according to a preferred embodiment of the present invention is, for example, preferably about 8% by mass or greater, and more preferably about 10% by mass or greater. The content of 3-methoxy-1-butanol in the aqueous inkjet ink according to a preferred embodiment of the present invention is, for example, preferably about 50% by mass or less, and more preferably about 40% by mass or less.

From the points of view of the quick drying property and the fixation of the ink and the image quality, it is preferable that a water-soluble organic solvent having a boiling point of about 220° C. or lower is included at a content of about 75% by mass or greater in the water-soluble organic solvent component (C).

If the content of the water-soluble organic solvent component (C) in the aqueous inkjet ink is too low, the drying property tends to be decreased, and the wettability of the aqueous inkjet ink with respect to the non-absorbent substrate is decreased. The decrease in the wettability may decrease the fixation and the image quality. Therefore, the content of the water-soluble organic solvent component (C) in the aqueous inkjet ink according to a preferred embodiment of the present invention is, for example, preferably about 10% by mass or greater, more preferably about 15% by mass or greater, and still more preferably about 20% by mass or greater. By contrast, if the content of the water-soluble organic solvent component (C) is too high, the viscosity of the ink tends to be increased. Therefore, the content of the water-soluble organic solvent component (C) in the aqueous inkjet ink according to a preferred embodiment of the present invention is, for example, preferably about 55% by mass or less, more preferably about 45% by mass or less, and still more preferably about 40% by mass or less.

### Silicone-Based Surfactant (D)

A surfactant is a component that adjusts the surface tension and the interfacial tension to be adequate. According to a preferred embodiment of the present invention, a silicone-based surfactant is preferably used among various types of surfactants.

As the silicone-based surfactant (D), any known silicone-based surfactant may be used with no specific limitation. The silicone-based surfactant is also available commercially. Examples of such commercially available silicone-based surfactants include BYK-306, BYK-307, BYK-333, BYK-345, BYK-346, BYK-347, BYK-348, and BYK-349 (produced by BYK Japan, K.K.); KF-351A, KF-352A, KF-353, KF-354L, KF-355A, KF-615A, KF-945, KF-640, KF-642, KF-643, KF-6020, X-22-4515, KF-6011, and KF-6012 (produced by Shin-Etsu Chemical Co., Ltd.); Silface SAG002, SAG005, SAG503A, and SAG008 (produced by Nisshin Chemical Industry Co., Ltd.); and the like. As the silicone-based surfactant (D), a polyether-modified silicone-based surfactant is preferable.

The content of the silicone-based surfactant (D) in the aqueous inkjet ink according to a preferred embodiment of the present invention is, for example, preferably about 0.1% by mass or greater, more preferably about 0.15% by mass or greater, and still more preferably about 0.2% by mass or greater. The content of the silicone-based surfactant (D) is, for example, preferably about 2% by mass or less, more preferably about 1.5% by mass or less, and still more preferably about 1.2% by mass or less.

### Resin Microparticles (E)

Resin microparticles (E) form a binder component that increases the fixation to the non-absorbent substrate and the tolerance of an ink film.

The resin microparticles (E) include a functional group reactive with a carbodiimide group at least at a surface thereof. Examples of the functional group reactive with a carbodiimide group include a carboxyl group, a hydroxyl group, an amino group, an amide group, a sulfonic acid group, a phosphoric acid group, and the like. Among these, a carboxyl group, a sulfonic acid group, and a phosphoric acid group are preferable.

The resin microparticles (E) may be made of a resin including a functional group reactive with a carbodiimide group, or may be resin microparticles in which a functional group reactive with a carbodiimide group has been incorporated into resin microparticles not having a functional group reactive with a carbodiimide group by surface treatment or the like. Examples of resins that form the resin microparticles (E) include a urethane resin, a polyester resin, an acrylic resin, a vinyl acetate resin, a polyethylene resin, a polypropylene resin, a fluoroolefin resin, a butadiene resin, a styrene resin, a styrene-butadiene resin, a styrene-acrylic resin, a vinyl chloride resin, an acrylic-silicone resin, and the like.

The resin microparticles (E) do not need to be made of one type of resin, and may be made of two or more types of resins. For example, core-shell type microparticles including a core portion and a shell portion having different resin compositions from each other, microparticles obtained as a result of emulsion polymerization, with pre-produced acrylic microparticles (seed particles), of a different type of monomer in order to control the particle size, or the like may be used. Alternatively, hybrid resin microparticles obtained as a result of chemical bonding of resin particles made of different resins, for example, microparticles made of an acrylic resin and microparticles made of a urethane resin, may be used.

The resin microparticles (E) preferably include an acrylic resin or a urethane resin at least in a surface portion thereof because these resins have a high fixing ability and a high ink stability.

There is no specific limitation on the volume-average particle size of the resin microparticles (E). The volume-average particle size is, for example, preferably about 10 to about 1000 nm, more preferably about 10 to about 200 nm, and still more preferably about 10 to about 50 nm. The volume-average particle size may be determined by use of, for example, a particle size distribution meter.

The content of the resin microparticles (E) in the aqueous inkjet ink according to a preferred embodiment of the present invention is, for example, preferably about 3% by mass or greater, and more preferably about 5% by mass or greater as the solid quantity (solid content concentration). The content of the resin microparticles (E) in the aqueous inkjet ink according to a preferred embodiment of the present invention is, for example, preferably about 15% by mass or less, and more preferably about 12% by mass or less as the solid quantity (solid content concentration).

### Water-Soluble Carbodiimide Compound (F)

The water-soluble carbodiimide compound (F) is a compound that includes a carbodiimide group (—N═C═N—) and a hydrophilic group, and is water-soluble. A compound usable as the water-soluble carbodiimide compound (F) is soluble in 25° C. water preferably at a concentration of, for example, about 10% by mass or greater, more preferably at a concentration of about 20% by mass or greater, and still more preferably at a concentration of about 35% by mass or greater. A compound preferably usable as the water-soluble carbodiimide compound (F) is a water-soluble polycarbodiimide compound including a plurality of carbodiimide groups.

As the water-soluble carbodiimide compound (F), any known water-soluble carbodiimide compound may be used with no specific limitation. The water-soluble carbodiimide compound is preferably also available commercially. Examples of such commercially available water-soluble carbodiimide compounds include Carbodilite V-02, V-02-L2, SV-02, V-04 and V-10 (produced by Nisshinbo Chemical Inc.).

The mass ratio of the resin microparticles (E) with respect to the water-soluble carbodiimide compound (F), namely, the mass ratio (E)/(F), is about 10 or greater, for example. If the mass ratio is less than about 10, the content of the water-soluble carbodiimide compound (F) is excessive and thus a sufficient level of rubfastness is not provided. The mass ratio is, for example, preferably about 50 or less, and more preferably about 30 or less.

The aqueous inkjet ink according to a preferred embodiment of the present invention may include, in addition to the above components, an additive such as a preservative, a fungicide, a thickener, an anti-foam agent, a pH adjuster, a rust-inhibitor or the like in a range in which the effects of preferred embodiments of the present invention are not significantly spoiled.

The aqueous inkjet ink according to a preferred embodiment of the present invention may be produced by mixing the components according to a known method. For example, the aqueous inkjet ink according to a preferred embodiment of the present invention may be produced by mixing water (A), an emulsion including a coloring material (B), a water-soluble organic solvent (C), a silicone-based surfactant (D), an emulsion including resin microparticles (E), an aqueous solution of a water-soluble carbodiimide compound (F), and other components uniformly by use of a known mixing device or a known stirring device.

The aqueous inkjet ink according to a preferred embodiment of the present invention, when used to print on a PVC substrate, forms an image with little ink bleeding, a high optical concentration value, and superb rubfastness. A conceivable reason for this is the following. In general, an aqueous inkjet ink forms a clear image on a substrate on which ink drops are easily spread while wet (wet-spread), such as an offset coated paper sheet or the like. However, on a PVC substrate, the aqueous inkjet ink does not easily wet-spread. Therefore, in the case in which an aqueous inkjet ink is used to perform inkjet printing on a PVC substrate, before an ink drop sufficiently wet-spreads, an adjacent dot lands and is combined with the first ink drop. Therefore, a concentration gradient occurs to cause ink bleeding from the formed image. In addition, the ink drops do not sufficiently wet-spread, and thus a plain image may have concentration unevenness. As a result, the optical concentration value (OC value) of the entire image is decreased by the influence of a thin-color portion of the image. In addition, there is another problem that the optical concentration of the aqueous inkjet ink itself is low.

By contrast, the aqueous inkjet ink according to a preferred embodiment of the present invention preferably includes a silicone-based surfactant (D) as a surfactant. Use of the silicone-based surfactant (D) significantly improves the wet-spreadability of the ink drops on a PVC substrate. Due to this, dots are uniformly formed on the PVC substrate. Namely, the occurrence of the concentration gradient is significantly reduced or prevented, and thus the ink bleeding from the image is significantly reduced or prevented. In addition, the concentration unevenness is significantly reduced or prevented, and thus the decrease in the optical concentration value is also significantly reduced or prevented.

In addition, the aqueous inkjet ink according to a preferred embodiment of the present invention also includes a water-soluble carbodiimide compound (F). Furthermore, the resin microparticles (E) include a functional group reactive with a carbodiimide group at least at a surface thereof. According to studies and consideration of the present inventors, a conceivable reason why conventional aqueous inkjet inks decrease the optical concentration value of an image is the following: when the resin microparticles are formed into a film in a drying step during the printing, polymer chains are not aligned irregularly but are oriented regularly; and a portion of the film formed of the resin microparticles is crystallized, which provides an image clouded in white. The water-soluble carbodiimide compound (F) included in the aqueous inkjet ink according to a preferred embodiment of the present invention is a crosslinking component. In the drying step, the carbodiimide group in the water-soluble carbodiimide compound (F) reacts with and is crosslinked with the above-mentioned functional group present at the surface of the resin microparticles (E). This crosslinking reaction restricts the motion of the molecules of the polymer chains, and thus suppresses the regular alignment of the polymer chains during the formation of the resin film. As a result, the formation of the crystallized portion in the formed resin film is significantly reduced or prevented, and thus the image is prevented from being clouded in white. Namely, the decrease in the optical concentration value is significantly reduced or prevented. According to a preferred embodiment of the present invention, among various carbodiimide compounds, a water-soluble carbodiimide compound is used in order to allow the crosslinking reaction to progress quickly. As shown by the examples and comparative examples described below, the decrease in the optical concentration value is significantly reduced or prevented by a combination of the silicone-based surfactant (D) and the water-soluble carbodiimide compound (F). In the meantime, in order to guarantee a sufficient level of rubfastness, the mass ratio of the resin microparticles (E) with respect to the water-soluble carbodiimide compound (F), namely, the mass ratio (E)/(F), is preferably about 10 or greater.

As described above, the aqueous inkjet ink according to a preferred embodiment of the present invention is preferably usable especially to print on a PVC substrate. The aqueous inkjet ink according to a preferred embodiment of the present invention is also usable to print (image formation) on a substrate other than a PVC substrate, for example, non-absorbent substrates such as a PET substrate, a surface-treated (corona-treated) polyethylene (PE) substrate, a surface-treated (corona-treated) polypropylene (PP) substrate, a polystyrene substrate and the like; and paper substrates such as art paper, coated paper, cast paper, wood-free paper, synthetic paper, paper for inkjet, and the like. The aqueous inkjet ink according to a preferred embodiment of the present invention is preferably usable to print on a non-absorbent substrate.

In another aspect, a preferred embodiment of the present invention relates to an inkjet recording method including a step of ejecting the above-described inkjet ink (the aqueous inkjet ink according to preferred embodiments of the present invention described above) toward a medium including a non-absorbent substrate (hereinafter, also referred to as an “ejection step”) and a step of drying the inkjet ink ejected on the medium to form an ink film (hereinafter, also referred to as a “film formation step”).

Usable as the non-absorbent substrate are a PVC substrate, a PET substrate, a surface-treated (corona-treated) PE substrate, a surface-treated (corona-treated) PP substrate, a polystyrene substrate and the like. Among these substrates, a PVC substrate is preferable.

In the ejection step, the inkjet ink is ejected toward the non-absorbent substrate of the medium. An inkjet recording method according to a preferred embodiment of the present invention may further include a step of heating the medium before the ejection step. When the medium is heated, the surface temperature of the medium is, for example, about 30° C. or higher and lower than the softening point of the medium (preferably, about 30° C. to about 80° C.)

In the film formation step, the medium may be heated in order to promote drying. When the medium is heated, the surface temperature of the medium is, for example, about 30° C. or higher and lower than the softening point of the medium (preferably, about 30° C. to about 80° C.).

The inkjet recording method according to a preferred embodiment of the present invention may include a step of cutting the medium (hereinafter, referred to also as a “cutting step”) after the film formation step.

The inkjet recording method according to a preferred embodiment of the present invention forms an image with little ink bleeding, a high optical concentration value, and superb rubfastness.

The inkjet recording method according to a preferred embodiment of the present invention is performed preferably using an inkjet recording device including a conveyer that transports a medium including a non-absorbent substrate, a heater that heats the transported medium, an ejector that ejects inkjet ink toward the heated medium, and an ink container that contains the inkjet ink and supplies the inkjet ink to the ejector. The inkjet ink is the above-described inkjet ink (the aqueous inkjet ink according to preferred embodiments of the present invention described above).

As an example, an inkjet recording device according to a preferred embodiment will be described with reference to the FIGURE. The FIGURE is a conceptual view of an inkjet recording device 100 according to a preferred embodiment of the present invention. The inkjet recording device 100 includes a conveyer 20 that transports a medium 10 including a non-absorbent substrate. The conveyer 20 preferably includes a supply roller 21, a take-up roller 22, and a transportation roller 23. The medium 10 is fed from the supply roller 21, passes over a platen 30 while being transported by the transportation roller 23, and is taken up by the take-up roller 22. Therefore, in this preferred embodiment, a direction of transporting the medium 10 is from the supply roller 21 toward the take-up roller 22. The medium 10 is shown for the sake of convenience, and is not an element of the inkjet recording device 100. As the medium 10, a medium including a PVC substrate is preferable.

The inkjet recording device 100 includes a heater 40. The heater 40 preferably functions as a preheater to heat the medium 10. The heater 40 includes, for example, a contact-heat sheet heater, a radiation heater that radiates infrared waves or microwaves, or a warm air heater. The heater 40 may be located above or below the medium 10, or may be located above and below the medium 10. Heating conditions for the heater 40 are set such that the temperature of the medium 10 is, for example, about 30° C. or higher and lower than the softening point thereof (such that the temperature of the medium 10 is preferably about 30° C. to about 80° C.)

The inkjet recording device 100 includes an ejector 50 that ejects the inkjet ink 11 toward the medium 10. The ejector is located downstream with respect to the heater 40 in the transportation direction of the medium 10. The ejector 50 includes an inkjet head that ejects the inkjet ink 11 in the form of liquid drops from a microscopic nozzle that uses, for example, vibration of a piezoelectric element. The inkjet recording device 100 includes an ink container 60. The ink container 60 is connected with the ejector 50. The ink container 60 includes, for example, an ink cartridge. Before being ejected, the inkjet ink 11 is contained in the ink container 60. The inkjet ink 11 contained in the ink container 60 is supplied to the ejector 50 when necessary. The inkjet ink 11 is the above-described aqueous inkjet ink (the aqueous inkjet ink according to preferred embodiments of the present invention described above).

The inkjet recording device 100 preferably includes a drier 70 that dries the ejected inkjet ink 11. The drier 70 is located downstream with respect to the ejector 50 in the transportation direction of the medium 10, and is preferably provided in a carriage 71. The drier 70 includes, for example, a heater such as a radiation heater that radiates infrared waves or microwaves, a warm air heater or the like, or an air blowing drier. Drying conditions for the drier 70 are set such that the inkjet ink 11 attached to the medium 10 is dried to form an image. Drying conditions are appropriately selected in accordance with the type and the amount of the solvent contained in the inkjet ink 11. The drier 70 is preferably a heater, and heating conditions for the heater are set such that the temperature of the medium 10 is, for example, about 30° C. or higher and lower than a softening point of the medium 10 (such that the temperature of the medium 10 is preferably about 30° C. to about 80° C.).

The inkjet recording device according to a preferred embodiment of the present invention forms an image with little ink bleeding, a high optical concentration value, and superb rubfastness.

Hereinafter, various preferred embodiments of the present invention will be described in detail by way of examples. The present invention is not limited to any of the following examples.

### Preparation of Inkjet Ink

The components shown in Table 1 through Table 3 were mixed uniformly at a mass ratio shown in the tables to obtain examples and comparative examples of inkjet inks. The obtained inkjet inks were used to perform printing on a PVC film using an inkjet printer, and were evaluated regarding the ink bleeding from the image, the OD value, and the rubfastness by the methods described below. The surface temperature of the PVC film was raised to 30° C. to 45° C. before the printing, and was raised to 40° C. to 50° C. after the printing. For the evaluation of the ink bleeding from the image, a fully plain image with a 5 pt white letter “L” on a colored background was made under the conditions that the amount of the ink was 22 pl per drop and that the resolution was 600 dpi×600 dpi. For the evaluation of the OD value and the rubfastness, a fully plain image was formed under the conditions that the amount of the ink was 22 pl per drop and that the resolution was 600 dpi×600 dpi. The evaluation results are shown in Table 1 through Table 3.

### Evaluation on the Ink Bleeding

The degree of ink bleeding of the image with a white letter “L” formed of ink dots on a colored background was visually observed. Based on the observation results, the degree of ink bleeding was evaluated with the following criteria. “◯” and “Δ” indicate that the test was passed.

◯: The white letter was highly visually identifiable.

Δ: Ink was slightly bleeding into the white letter, but the white letter was visually identifiable.

X: Ink was bleeding and the white letter was not visually identifiable.

### Evaluation on the OD Value

The OD value of the fully plain image was measured three times and the average value thereof was obtained. The OD value was evaluated with the following criteria. “◯” and “Δ” indicate that the test was passed.

### Examples 1 Through 8 and Comparative Examples 1 Through 4

◯: 2.0 or higher

Δ: 1.8 or higher and lower than 2.0

X: Lower than 1.8

### Example 9 and Comparative Examples 5 and 6

◯: 1.4 or higher

Δ: 1.2 or higher and lower than 1.4

X: Lower than 1.2

### Evaluation on the Rubfastness

A piece of dry cloth was attached to a JSPS (Japan Society for the Promotion of Science) tester. The cloth, with a weight of 500 g attached thereto, was moved reciprocally 100 times on an ink film of the plain image. Then, the state of the ink film was observed. Based on the observation results, the rubfastness was evaluated with the following criteria. “◯” and “Δ” indicate that the test was passed.

◯: No ink film was removed.

Δ: Only a portion of the ink film was removed.

X: Half or more of the ink film was removed.

TABLE 1

| | | Example | Example | Example | Example | Example | Example | Example | Example |
|---|---|---|---|---|---|---|---|---|---|
| | Remarks | 1 | 2 | 3 | 4 | 5 | 6 | 7 | 8 |
| CAB-O-JET 300 (15% .aq) | Coloring material | 16 | 16 | 16 | 16 | 16 | 16 | 16 | 16 |
| CAB-O-JET 260M (10% .aq) | Coloring material | | | | | | | | |
| Triethyleneglycolmono- | Boiling point 278° C. | 5 | 5 | 5 | 5 | 5 | 5 | 5 | 5 |
| butylether | | | | | | | | | |
| Propyleneglycol | Boiling point 188° C. | 10 | 10 | 10 | 10 | 10 | 10 | 10 | 10 |
| 3-methoxy-1-butanol | Boiling point 158° C. | 15 | 15 | 15 | 15 | 15 | 15 | 15 | 15 |
| SAG 002 | Silicone-based surfactant | 0.4 | 0.4 | 0.4 | 0.4 | 0.4 | | 0.4 | 0.4 |
| SAG 503A | Silicone-based surfactant | | | | | | 0.4 | 0.4 | |
| E1010 | Acetyleneglycol-based | | | | | | | | |
| | surfactant | | | | | | | | |
| Vinyblan 715S (25% .aq) | Vinyl Chloride-urethane | 32 | 32 | 32 | 32 | 32 | 32 | 32 | |
| | core-shell type | | | | | | | | |
| | resin microparticles | | | | | | | | |
| PE1126 (41% .aq) | Acrylic resin microparticles | | | | | | | | 19.5 |
| SV-02 (40% .aq) | Water-soluble carbodiimide | 1 | | 0.5 | 1.5 | 2 | 1 | 1 | 1 |
| V-04 (40% .aq) | Water-soluble carbodiimide | | 1 | | | | | | |
| E-05 (40% .aq) | Water-dispersible carbodiimide | | | | | | | | |
| Water | Separately added | 20.6 | 20.6 | 21.1 | 20.1 | 19.6 | 20.6 | 20.2 | 33.1 |
| Total | | 100 | 100 | 100 | 100 | 100 | 100 | 100 | 100 |
| Total amount of water | | 58.8 | 58.8 | 59.0 | 58.6 | 58.4 | 58.8 | 58.4 | 58.8 |
| Coloring material | | 2.4 | 2.4 | 2.4 | 2.4 | 2.4 | 2.4 | 2.4 | 2.4 |
| Water-soluble organic solvent | | 30 | 30 | 30 | 30 | 30 | 30 | 30 | 30 |
| Surfactant | | 0.4 | 0.4 | 0.4 | 0.4 | 0.4 | 0.4 | 0.8 | 0.4 |
| Resin microparticles | | 8.0 | 8.0 | 8.0 | 8.0 | 8.0 | 8.0 | 8.0 | 8.0 |
| Carbodiimide compound | | 0.4 | 0.4 | 0.2 | 0.6 | 0.8 | 0.4 | 0.4 | 0.4 |
| Resin microparticles/ | | 20 | 20 | 40 | 13 | 10 | 20 | 20 | 20 |
| carbodiimide compound ratio | | | | | | | | | |
| Ink bleeding | | ◯ | ◯ | ◯ | ◯ | ◯ | ◯ | ◯ | ◯ |
| OD value | | ◯ | ◯ | Δ | ◯ | ◯ | ◯ | ◯ | ◯ |
| Rubfastness | | ◯ | ◯ | ◯ | ◯ | Δ | ◯ | ◯ | ◯ |

TABLE 2

| | | Comparative | Comparative | Comparative | Comparative |
|---|---|---|---|---|---|
| | Remarks | example 1 | example 2 | example 3 | example 4 |
| CAB-O-JET 300 (15%, aq) | Coloring material | 16 | 16 | 16 | 16 |
| CAB-O-JET 260M (10%, aq) | Coloring material | | | | |
| Triethyleneglycolmonobutylether | Boiling point 278° C. | 5 | 5 | 5 | 5 |
| Propyleneglycol | Boiling point 188° C. | 10 | 10 | 10 | 10 |
| 3-methoxy-1-butanol | Boiling point 158° C. | 15 | 15 | 15 | 15 |
| SAG 002 | Silicone-based surfactant | 0.4 | 0.4 | 0.4 | |
| SAG 503A | Silicone-based surfactant | | | | |
| E1010 | Acetyleneglycol-based surfactant | | | | 0.4 |
| Vinyblan 715S (25%, aq) | Vinyl chloride-urethane core-shell type | 32 | 32 | 32 | 32 |
| | resin microparticles | | | | |
| PE1126 (41%, aq) | Acrylic resin microparticles | | | | |
| SV-02 (40%, aq) | Water-soluble carbodiimide | | | 2.5 | 1 |
| V-04 (40%, aq) | Water-soluble carbodiimide | | | | |
| E-05 (40%, aq) | Water-dispersible carbodiimide | | 1 | | |
| Water | Separately added | 21.6 | 20.6 | 19.1 | 20.6 |
| Total | | 100 | 100 | 100 | 100 |
| Total amount of water | | 59.2 | 58.8 | 58.2 | 58.8 |
| Coloring material | | 2.4 | 2.4 | 2.4 | 2.4 |
| Water-soluble organic solvent | | 30 | 30 | 30 | 30 |
| Surfactant | | 0.4 | 0.4 | 0.4 | 0.4 |
| Resin microparticles | | 8.0 | 8.0 | 8.0 | 8.0 |
| Carbodiimide compound | | 0 | 0.4 | 1.0 | 0.4 |
| Resin microparticles/carbodiimide | | — | 20 | 8 | 20 |
| compound ratio | | | | | |
| Ink bleeding | | ◯ | ◯ | ◯ | X |
| OD value | | X | X | ◯ | X |
| Rubfastness | | ◯ | ◯ | X | ◯ |

TABLE 3

| | | | Comparative | Comparative |
|---|---|---|---|---|
| | Remarks | Example 9 | exmple 5 | example 6 |
| CAB-O-JET 300 (15%, aq) | Coloring material | | | |
| CAB-O-JET 260M (10%, aq) | Coloring material | 24 | 24 | 24 |
| Triethyleneglycolmonobutylether | Boiling point 278° C. | 5 | 5 | 5 |
| Propyleneglycol | Boiling point 188° C. | 10 | 10 | 10 |
| 3-methoxy-1-butanol | Boiling point 158° C. | 15 | 15 | 15 |
| SAG 002 | Silicone-based surfactant | 0.4 | 0.4 | |
| SAG 503A | Silicone-based surfactant | | | |
| E1010 | Actyleneglycol-based surfactant | | | 0.4 |
| Vinyblan 715S (25%, aq) | Vinyl chloride-urethane | 32 | 32 | 32 |
| | core-shell type | | | |
| | resin microparticles | | | |
| PE1126 (41%, aq) | Acrylic resin microparticles | | | |
| SV-02 (40%, aq) | Water-soluble carbodiimide | 1 | | 1 |
| V-04 (40%, aq) | Water-soluble carbodiimide | | | |
| E-05 (40%, aq) | Water-dispersible carbodiimide | | | |
| Water | Separately added | 12.6 | 13.6 | 12.6 |
| Total | | 100 | 100 | 100 |
| Total amount of water | | 58.8 | 59.2 | 58.8 |
| Coloring material | | 2.4 | 2.4 | 2.4 |
| Water-soluble organic solvent | | 30 | 30 | 30 |
| Surfactant | | 0.4 | 0.4 | 0.4 |
| Resin microparticles | | 8.0 | 8.0 | 8.0 |
| Carbodiimide compound | | 0.4 | 0 | 0.4 |
| Resin microparticles/carbodiimide | | 20 | — | 20 |
| compound ratio | | | | |
| Image bleeding | | ◯ | ◯ | X |
| OD value | | ◯ | X | X |
| Rubfastness | | ◯ | ◯ | ◯ |

The numerical value for each component in the tables represents the mass ratio.

CAB-O-JET300 (produced by Cabot Corporation): self-dispersible black-type pigment (aqueous emulsion having a solid content of 15% by mass)

CAB-O-JET260M (produced by Cabot Corporation): self-dispersible magenta-type pigment (aqueous emulsion having a solid content of 10% by mass)

SAG002 (produced by Nisshin Chemical Industry Co., Ltd.): silicone-based surfactant “Silface SAG002”

SAG503A (produced by Nisshin Chemical Industry Co., Ltd.): silicone-based surfactant “Silface SAG503A”

E1010 (produced by Nisshin Chemical Industry Co., Ltd.): acetyleneglycol-based surfactant “Olfine E1010”

Vinyblan 715S (produced by Nisshin Chemical Industry Co., Ltd.): aqueous emulsion of poly(vinyl chloride)-polyurethane core-shell particles (solid content: 25% by mass)

PE1126 (produced by Seiko PMC Corporation): acrylic resin aqueous emulsion (solid content: 41.5% by mass)

SV-02 (produced by Nisshinbo Chemical Inc.): aqueous solution of water-soluble carbodiimide “Carbodilite SV-02” (solid content: 40% by mass)

V-04 (produced by Nisshinbo Chemical Inc.): aqueous solution of water-soluble carbodiimide “Carbodilite V-04” (solid content: 40% by mass)

E-05 (produced by Nisshinbo Chemical Inc.): water-dispersible polycarbodiimide emulsion “Carbodilite E-05” (solid content: 40% by mass)

As seen from Table 1 through Table 3, an image with little ink bleeding, a high optical concentration value, and superb rubfastness was formed using the aqueous inkjet ink in each of examples 1 through 9 within the scope of the preferred embodiments of the present invention. From the results of examples 3 through 5, it is seen that in the case in which the ratio of the resin microparticles (E) with respect to the water-soluble carbodiimide (F), namely, (E)/(F), is low, the OD value tends to be higher; whereas in the case in which (E)/(F) is high, the rubfastness tends to be higher.

By contrast, as shown by the results of comparative example 1 in Table 2, in the case in which the aqueous inkjet ink does not include a water-soluble carbodiimide compound, the OD value is low. A conceivable reason for this is the following: the water-soluble carbodiimide compound, which is a crosslinking component, is not present, and therefore the whitening caused by the crystallization of the resin, which is caused when the resin microparticles are formed into a film, is not prevented. As shown by the results of comparative example 2, in the case in which the aqueous inkjet ink includes a water-dispersible carbodiimide compound, the OD value is low. A conceivable reason for this is the following: the carbodiimide compound, which is a crosslinking component, is not water-soluble but is water-dispersible, and therefore the crosslinking reaction does not advance quickly in the drying step. As shown by the results of comparative example 3, in the case in which the ratio of the resin microparticles with respect to the water-soluble carbodiimide compound is too small in the aqueous inkjet ink, the rubfastness is poor. A conceivable reason for this is the following: the amount of the water-soluble carbodiimide compound is excessive, and therefore a large portion of the water-soluble carbodiimide compound remains unreacted in the ink film. As shown by the results of comparative example 4, in the case in which the aqueous inkjet ink includes an acetyleneglycol-based surfactant, the ink bleeds heavily from the image and the OD value is low. A conceivable reason for this is the following: the ink including an acetyleneglycol-based surfactant wet-spreads more slowly than the ink including a silicone-based surfactant. As shown in Table 3, substantially the same tendency is exhibited in the case in which a different type of coloring material is used.

The present invention may be embodied in other forms without departing from the spirit or essential characteristics thereof. The preferred embodiments of the present invention disclosed in this specification are to be considered in all respects as illustrative and not limiting. The scope of the present invention is indicated by the appended claims rather than by the foregoing description, and all changes which are within the meaning and range of equivalency of the claims are intended to be embraced therein.

Aqueous inkjet inks according to the preferred embodiments of the present invention are especially preferably useful to print on a PVC substrate, and are also useful to print (image formation) on a substrate other than a PVC substrate, for example, non-absorbent substrates such as a PET substrate, a surface-treated (corona-treated) polyethylene (PE) substrate, a surface-treated (corona-treated) polypropylene (PP substrate), a polystyrene substrate and the like; and paper substrates such as art paper, coated paper, cast paper, wood-free paper, synthetic paper, paper for inkjet, and the like. The aqueous inkjet inks according to preferred embodiments of the present invention are preferably useful to print on a non-absorbent substrate.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An aqueous inkjet ink comprising:
water;
a coloring material;
a water-soluble organic solvent component;
a surfactant;
resin particles; and
a water-soluble carbodiimide compound that acts as a crosslinking component; wherein
the surfactant is a silicone-based surfactant;
the resin microparticles include a functional group that is reactive with a carbodiimide group at least at a surface of the resin microparticles; and
a mass ratio of the resin microparticles with respect to the water-soluble carbodiimide compound is about 10 or greater.

2. The aqueous inkjet ink according to claim 1, wherein the coloring material is a black pigment.

3. The aqueous inkjet ink according to claim 1, wherein the resin microparticles include an acrylic resin or a urethane resin at least in a surface portion thereof.

4. An inkjet recording method comprising the steps of:
ejecting the aqueous inkjet ink according to claim 1 toward a medium including a non-absorbent substrate; and
drying the aqueous inkjet ink ejected on the medium to form an ink film.

5. The inkjet recording method according to claim 4, wherein the non-absorbent substrate includes poly(vinyl chloride).

6. An inkjet recording device comprising:
a conveyer that transports a medium including a non-absorbent substrate;
a heater that heats the medium;
an ejector that ejects an inkjet ink toward the heated medium; and
an ink container that contains the inkjet ink and supplies the inkjet ink to the ejector; wherein
the inkjet ink is the aqueous inkjet ink according to claim 1.
